(19) United States
(12) Patent Application Publication
(10) Pub. No.: US 2006/0197898 A1
(43) Pub. Date: Sep. 7, 2006

(54) Liquid crystal device and electronic apparatus

(75) Inventor: Hayato Kurasawa, Matsumoto (JP)

Correspondence Address: HARNESS, DICKEY & PIERCE, P.L.C., P.O. BOX 828, BLOOMFIELD HILLS, MI, 48303, US

(73) Assignee: Sanyo Epson Imaging Devices Corp.

(21) Appl. No.: 11/333,605

(22) Filed: Jan. 17, 2006

(30) Foreign Application Priority Data
Mar. 3, 2005 (JP) 2005-58470

(51) Int. Cl. G02F 1/1335

(52) U.S. Cl. 349/117

(57) ABSTRACT

A liquid crystal device includes a first substrate that has an inner surface on which a pixel electrode is formed; a second substrate that has an inner surface on which a counter electrode constituting a pixel is formed opposite to the pixel electrode; and a liquid crystal layer that is held between the first substrate and the second substrate and has negative dielectric anisotropy. In addition, an alignment control unit for controlling the alignment of the liquid crystal molecules is formed in an area including the center of the pixel electrode on either the first substrate or the second substrate; and the pixel electrode has an approximately polygonal shape, and slits extending from an outer periphery toward the center are formed at corner portions of the pixel electrode.

### RELATED APPLICATIONS

This application claims priority to Japanese Patent Application No. 2005-58470 filed Mar. 3, 2005 which is hereby expressly incorporated by reference herein in its entirety.

### BACKGROUND

1. Technical Field

The present invention relates to a liquid crystal device using liquid crystal having negative dielectric anisotropy, and to an electronic apparatus having the liquid crystal device.

2. Related Art

Generally, an active-matrix-type liquid crystal device includes a first substrate that has an inner surface on which a pixel electrode is formed, a second substrate that has an inner surface on which a counter electrode constituting a pixel is formed opposite to the pixel electrode, and a liquid crystal layer that is held between the first substrate and the second substrate. In such a liquid crystal device, as a technology for improving a visual angle characteristic, a technology adopting a VA (vertical alignment) mode in which liquid crystal having negative dielectric anisotropy is vertically aligned to a substrate and liquid crystal molecules are tilted by voltage application has been suggested (for example, see Asia Display/IDW'01, p 133 (2001), Makoto Jisaki and Hidemasa Yamaguchi (hereinafter, referred to as Non-Patent Document 1)).

In Non-Patent Document 1, a technology has been suggested in which a transmissive display region has a regular octagonal shape, and a protrusion is formed at the center of the counter substrate such that the liquid crystal molecules are tilted in all directions of 360 degrees in the transmissive display region. Furthermore, in a transflective liquid crystal device, it is proposed to make a thickness of a liquid crystal layer of a reflective display region smaller than that of a transmissive display region so as to eliminate a difference in retardation (Δn·d) between transmissive display light and reflective display light.

Furthermore, for a liquid crystal device adopting the VA mode, as shown in FIG. 14, it is proposed to divide a pixel electrode 12X into a plurality of sub-pixel electrodes 121X and 122X, provide an alignment control unit 190X at the center location of each of the divided sub-pixel electrodes 121X and 122X, and form a plurality of slits 40X around the entire outer peripheries of the sub-pixel electrodes 121X and 122X (for example, see SID2004 Session3 AMLCD TECHNOLOGY1 ‘3.1 MVD LCD for Notebook or Mobile PC's with High Transmittance, High Contrast Ratio, and Wide View Angle’ (hereinafter, referred to as Non-Patent Document 2)).

However, as disclosed in Non-Patent Document 2, when a plurality of slits are formed around the entire outer peripheries of the sub-pixels, since an area of the slits not directly contributing to the display is large, there is a problem in that a pixel aspect ratio (ratio of portions directly contributing to the display to the entire pixels) may be notably lowered, and thus bright images cannot be displayed.

### SUMMARY

An advantage of some aspects of the invention is that it provides a liquid crystal device which is capable of controlling the alignment of liquid crystal molecules without lowering a pixel opening ratio by effectively disposing slits around an outer periphery of a pixel electrode even when a liquid crystal material having negative dielectric anisotropy is used, and an electronic apparatus having the liquid crystal device.

According to a first aspect of the invention, there is provided a liquid crystal device including: a first substrate that has an inner surface on which a pixel electrode is formed; a second substrate that has an inner surface on which a counter electrode constituting a pixel is formed opposite to the pixel electrode; and a liquid crystal layer that is held between the first substrate and the second substrate and has negative dielectric anisotropy. In addition, an alignment control unit that controls the alignment of liquid crystal molecules is formed in an area including a center of the pixel electrode on either the first substrate or the second substrate. The pixel electrode has an approximately polygonal shape, and slits extending from outer peripheries toward the center are formed at corner portions of the pixel electrode.

Preferably, the alignment control unit is formed of a protrusion formed in an area including the center of the pixel electrode in at least one of the inner surface of the first substrate and the inner surface of the second substrate, or is formed of an opening formed in an area including the center of the pixel electrode in at least one of the pixel electrode and the counter electrode.

According to this aspect, since the liquid crystal layer is made of a liquid crystal material having negative dielectric anisotropy, and an alignment control unit that controls the alignment of the liquid crystal molecules is formed in an area that includes the center of the pixel electrode, at the time of voltage application, the vertically aligned liquid crystal molecules at the center portions of the pixel electrode can be tilted in all directions of 360 degrees, thereby achieving a superior visual angle characteristic. Also, in the case of a polygonal pixel electrode, since the corner portions are spaced apart from the alignment control unit, the regulation force by the alignment control unit at the center area of the pixel electrode becomes weaker. However, according to this aspect, the slits are formed at the corner portions, and the alignment of the liquid crystal molecules is controlled by the distortion in the electric field generated by the slits. Therefore, since the slits are only formed in the areas that are most likely subject to alignment disorder, the alignment of the liquid crystal molecules can be controlled without forming a plurality of slits around the entire outer peripheries of a plurality of pixel electrodes. As a result, as compared with the case in which a plurality of slits are formed around the entire outer peripheries of the pixel electrode, brighter display with a higher pixel aspect ratio can be achieved.

According to a second aspect of the invention, there is provided a liquid crystal device including: a first substrate that has an inner surface on which a pixel electrode is formed; a second substrate that has an inner surface on which a counter electrode constituting a pixel is formed opposite to the pixel electrode; and a liquid crystal layer that is held between the first substrate and the second substrate and has negative dielectric anisotropy. In addition, the pixel electrode is divided into a plurality of sub-pixel electrodes connected via connection portions, and slits are formed at outer peripheries of the plurality of sub-pixel electrodes, the slits extending from both sides of the connection portions with the connection portions interposed therebetween at sides where the connection portions are located toward centers of the corresponding sub-pixel electrodes.

Preferably, when the sub-pixel electrode has an approximately polygonal shape, the slits extend from corner portions of outer peripheries of the plurality of sub-pixel electrodes with the connection portions interposed therebetween at sides where the connection portions are located toward centers of the corresponding sub-pixel electrodes.

According to this aspect, since the liquid crystal layer is made of a liquid crystal material having negative dielectric anisotropy and the pixel-electrode is divided into sub-pixels, the vertically aligned liquid crystal molecules can be tilted in a predetermined direction by the oblique electric field at the outer periphery of each of the sub-pixels, thereby achieving a superior visual angle characteristic. In addition, when the pixel electrode is divided into sub-pixels, the sub-pixels are connected to one another via connection portions, and the alignment of the liquid crystal molecules are likely to be subject to alignment disorder at the portion corresponding to the connection portion. However, according to this aspect, since the slits are formed at the outer peripheries of the sub-pixel electrode, extending from both sides of the corresponding pixel electrodes with the connection portions interposed therebetween at sides where the connection portions are located toward centers of the corresponding sub-pixel electrodes, the alignment of the liquid crystal molecules near the connection portion can be efficiently controlled. Therefore, since the slits are only formed in the areas that are most likely subject to alignment disorder, the alignment of the liquid- crystal molecules can be controlled without forming a plurality of slits around the entire outer peripheries of a plurality of pixel electrodes. Therefore, in comparison with the case in which a plurality of slits are formed around the entire outer peripheries of the pixel electrode, brighter display with a higher pixel aspect ratio can be achieved.

According to a third aspect of the invention, there is provided a liquid crystal device including: a first substrate that has an inner surface on which a pixel electrode is formed; a second substrate that has an inner surface on which a counter electrode constituting a pixel is formed opposite to the pixel electrode; and a liquid crystal layer that is held between the first substrate and the second substrate and has negative dielectric anisotropy. In addition, the pixel electrode is divided into a plurality of sub-pixel electrodes connected via a connection portion, each of the plurality of sub-pixel electrodes is disposed so as to correspond to a transmissive display region that emits light incident from either the first substrate or the second substrate toward the other substrate and a reflective display region that reflects light incident from either the first substrate or the second substrate, the reflective display region has a liquid-crystal-layer thickness adjusting layer that makes the thickness of the liquid crystal layer in the reflective display region smaller than the thickness of the liquid crystal layer in the transmissive display region, and slits are formed in each of the plurality of sub-pixel electrodes, the slits extending from both sides located at an interface area side between the reflective display region and the transmissive display region toward a center of the corresponding sub-pixel electrode.

Preferably, when the sub-pixel electrode has an approximately polygonal shape, the slits extend from corner portions of the outer peripheries of the plurality of sub-pixel electrodes which are located in the interface area toward the centers of the corresponding sub-pixel electrodes.

According to this aspect, since the liquid crystal layer is made of a liquid crystal material having negative dielectric anisotropy and the pixel-electrode is divided into sub-pixels, the vertically aligned liquid crystal molecules can be tilted in a predetermined direction by the oblique electric field at the outer periphery of each of the sub-pixels, thereby achieving an superior visual angle characteristics. Also, the pixel electrode is divided into sub-pixel electrodes, each of the sub-pixel electrodes corresponds to a transmissive display region or a reflective display region, and a liquid-crystal-layer thickness adjusting layer is formed on the reflective display region, which makes the thickness of the liquid crystal layer in the reflective display region smaller than the thickness of the liquid crystal layer in the transmissive display region. Therefore, since the difference in retardation (Δn·d) between the transmissive display light and the reflective display light is eliminated, both the transmissive display light and the reflective display light are preferably light-modulated. In this case, a step of the liquid-crystal-layer thickness adjusting layer is located near the interface area between the transmissive display region and the reflective display region, and by the step, the liquid crystal molecules is subject to alignment disorder. However, since oblique slits extend from both side portions located in the interface area between the reflective display region and the transmissive display region toward the center of the sub-pixel electrode, the alignment of the liquid crystal molecules near the interface area between the reflective display region and the transmissive display region can be controlled. Therefore, since the slits are only formed in the areas that are most likely subject to alignment disorder, the alignment of the liquid crystal molecules can be controlled without forming a plurality of slits around the entire outer peripheries of a plurality of pixel electrodes. As a result, as compared with the case in which a plurality of slits are formed around the entire outer peripheries of the pixel electrode, brighter display with a higher pixel aspect ratio can be achieved.

Preferably, an alignment control unit that controls the alignment of the liquid crystal molecules in the area including each of the centers of the sub-pixel electrodes is preferably formed either on the first substrate or on the second substrate. Through the structure, since the vertically aligned liquid crystal molecules at the center portion of the pixel electrode can be tilted in all directions of 360 degrees, a superior visual angle characteristic can be achieved, and the location of disclination can be fixed, thereby achieving a higher display quality.

Preferably, the alignment control unit is formed of a protrusion formed in an area including the center of the pixel electrode in at least one of the inner surface of the first substrate and the inner surface of the second substrate, or is formed of an opening formed in an area including the center of the pixel electrode in at least one of the pixel electrode and the counter electrode.

Preferably, a plurality of slits are formed parallel to each other at one place. In this case, the portion sandwiched by the slits may preferably protrude more toward the outer peripheral side than a peripheral region.

Preferably, the width of each slit is preferably equal to or smaller than 8 μm. If the width of each of the slits exceeds 8 μm, the effect of the oblique electric field generated by the slit becomes excessively large, and there is concern that the liquid crystal molecules of the entire pixel may be subject to alignment disorder. Also, if the width of each of the slits is equal to or smaller than 8 μm, since the alignment of the liquid crystal molecules can be controlled by the oblique electric field generated by the slits, portions corresponding to the silts can be light-modulated, thereby contributing to the display. Therefore, an amount of lost display light can be suppressed to a minimum, and a bright image can be displayed.

The liquid crystal device can be used for electronic apparatuses, such as a cellular phone, a mobile computer, or the like.

### BRIEF DESCRIPTION OF THE DRAWINGS

The invention will be described with reference to the accompanying drawings, wherein like numbers reference like elements.

FIG. 1 is a block diagram illustrating an electrical structure of a liquid crystal device according to a first embodiment of the invention;

FIG. 2A is a schematic perspective view of the liquid crystal device according to the first embodiment of the invention viewed from an oblique upside.

FIG. 2B is a diagram schematically illustrating a cross section of the liquid crystal device according to the first embodiment of the invention.

FIG. 3 is a plan view schematically illustrating a structure of a pixel corresponding to a single dot of the liquid crystal device according to the first embodiment of the invention.

FIG. 4 is an enlarged cross-sectional view of one of a plurality of pixels formed in the liquid crystal device according to the first embodiment of the invention;

FIG. 5 is a plan view schematically illustrating a structure of a pixel corresponding to a single dot of a liquid crystal device according to a second embodiment of the invention.

FIG. 6 is an enlarged cross-sectional view of one of a plurality of pixels formed in the liquid crystal device according to the second embodiment of the invention.

FIG. 7A is a diagram illustrating equipotential lines when slits are formed in a sub-pixel electrode in the liquid crystal device according to the second embodiment of the invention.

FIG. 7B is a diagram illustrating equipotential lines when slits are formed in a sub-pixel electrode in the liquid crystal device according to the second embodiment of the invention.

FIG. 8 is a plan view schematically illustrating a structure of a pixel corresponding to a single dot of a liquid crystal device according to a third embodiment of the invention.

FIG. 9 is an enlarged cross-sectional view of one of a plurality of pixels formed in the liquid crystal device according to the third embodiment of the invention.

FIG. 10 is a block diagram illustrating an electrical structure of a liquid crystal device according to a fourth embodiment of the invention.

FIG. 11A is a schematic perspective view of the liquid crystal device according to the fourth embodiment of the invention viewed from an oblique downside.

FIG. 11B is a diagram schematically illustrating a cross section of the liquid crystal device according to the fourth embodiment of the invention.

FIG. 12 is a plan view schematically illustrating a structure of a pixel corresponding to a single dot of the liquid crystal device according to the fourth embodiment of the invention;

FIG. 13 is an enlarged cross-sectional view of one of a plurality of pixels formed in the liquid crystal device according to the fourth embodiment of the invention; and

FIG. 14 is a plan view of a pixel electrode used in a liquid crystal device according to a reference example.

### DESCRIPTION OF EXEMPLARY EMBODIMENTS

Hereinafter, the preferred embodiments of the invention will be described with reference to the accompanying drawings. It is noted that in the following description, for convenience, two directions intersecting each other in the paper surface are denoted as an X direction and a Y direction, and the side to which display light is emitted is denoted as a ‘viewing surface side’, meaning the side at which the observer watching the display image is located. In addition, in the respective drawings used for the following description, the scale of each layer or each member has been adjusted in order to have a recognizable size.

### First Embodiment

General Structure

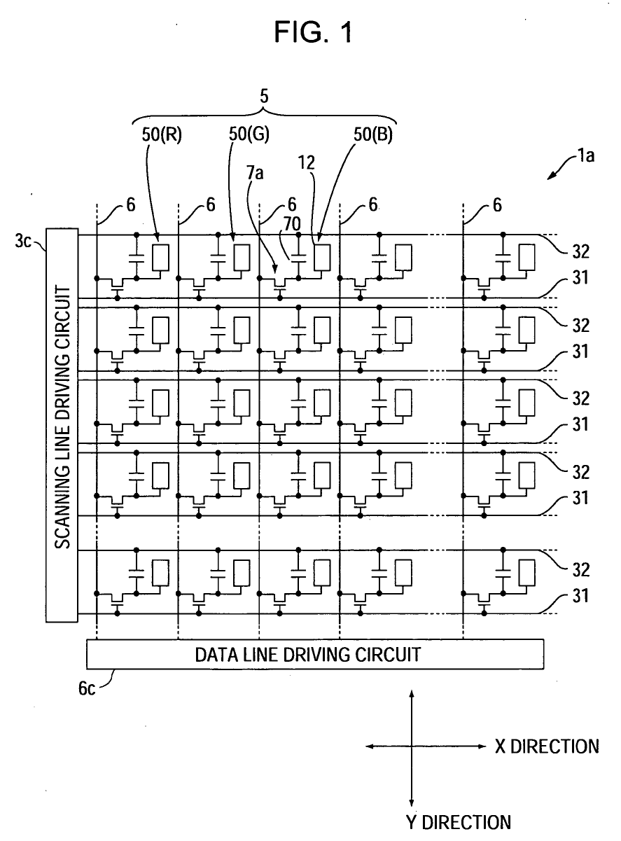

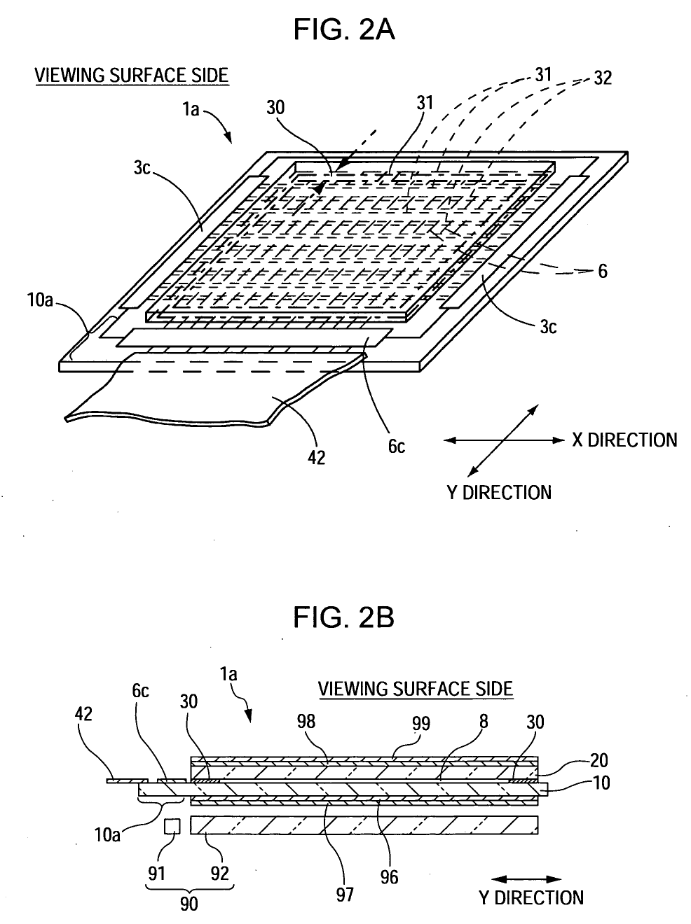

FIG. 1 is a block diagram illustrating an electrical structure of a liquid crystal device according to a first embodiment of the invention. FIG. 2A is a schematic perspective view of the liquid crystal device according to the first embodiment of the invention viewed from an oblique upside (counter substrate), and FIG. 2B is a diagram schematically illustrating a cross section of the liquid crystal device according to the first embodiment of the invention cut in a Y direction. It is noted that since the liquid crystal device according to the present embodiment is one for color display and thus pixels correspond to a red light component (R), a green light component (G), and a blue light component (B), reference numerals (R), (G), and (B) are affixed to the pixels corresponding to the respective colors.

The liquid crystal device 1a shown in FIG. 1 is a transmissive active-matrix-type liquid crystal device using thin film transistors (hereinafter, referred to as TFTs) serving as pixel switching elements, where a plurality of scanning lines 31 are formed in an X direction (row direction) and a plurality of data lines 6 are formed in a Y direction (column direction). A pixel 50 is formed at a location corresponding to each of intersections of the scanning lines 31 and the data lines 6, and a pixel switching TFT 7a (nonlinear element) is constructed in each pixel 50. Each of the scanning lines 31 is driven by a scanning line driving circuit 3c, and each of the data lines 6 is driven by a data line driving circuit 6c. The data lines 6 are electrically connected to sources of TFTs 7a, and the scanning lines 31 are electrically connected to gates of the TFTs 7a. Scan signals are supplied to the scanning lines 31 from the scanning line driving circuit 3c with a predetermined timing in a pulsed manner. Each of pixel electrodes 12 is connected to a drain of each of the TFTs 7a, and writes pixel signals supplied from the data lines 6 into each of the pixels with a predetermined timing by maintaining each of the TFTs 7a as an on state for a predetermined period. In this way, a pixel signal of a predetermined level written in the liquid crystal through the pixel electrode 12 is held for a predetermined period between the pixel electrode and a counter electrode formed on a counter substrate, which will be described in detail below. Here, for the purpose of preventing the held pixel signal from leaking, parallel to a liquid crystal capacitor formed between the pixel electrode 12 and the counter electrode, a storage capacitor 70 is additionally provided by using, for example, a capacitor line 32 or the like. For example, a voltage of the pixel electrode 12 may be held by the storage capacitor 70 for a longer time, namely, for a period as much as three orders of magnitude longer than the time for which the source voltage is applied. Accordingly, a charge holding characteristic can be improved, and a liquid crystal device capable of performing display with a high contrast ratio can be achieved.

Each of the plurality of pixels 50 corresponds to each of red (R), green (G), and blue (B) according to the colors of color filters, which will be described in detail below. Each of the pixels 50(R), 50(G) and 50(B) corresponding to each of the three colors functions as a sub-dot, and three pixels 50(R), 50(G), and 50(B) constitute a single dot 5. Accordingly, in the present embodiment, a plurality of dots 5 each of which has the three pixels 50(R), 50(G), and 50(B) are arranged in a matrix.

As shown in FIGS. 2A and 2B, in constituting the liquid crystal device 1a of the present embodiment, a liquid crystal layer 8 is formed by bonding an element substrate 10 (first substrate) disposed at the side opposite to the viewing surface side to a counter substrate 20 (second substrate) disposed at the viewing surface side through a sealant 30 (shown by one-dot chain line in FIG. 2A), and sealing a liquid crystal material serving as an electro-optical material in the region surrounded by both substrates and the sealant 30. The element substrate 10 and the counter substrate 20 are planar members having a light transmitting property, such as glass, quartz or the like. The sealant 30 is formed along the outer periphery of the counter substrate 20 in an approximately rectangular frame shape. However, a portion of the sealant 30 is opened in order to inject the liquid crystal. Therefore, after the liquid crystal is injected, the opening is sealed by a sealing material 33.

The element substrate 10 has an extending region 10a extending from one end of the counter substrate 20 to one side in a state in which it is bonded to the counter substrate 20 through the sealant 30, and the extending region 10a is connected to a flexible substrate 42. In addition, in the element substrate 10, a scanning line driving circuit 3c and a data line driving circuit 6c are formed of TFTs.

As shown in FIG. 2B, a backlight device 90 is disposed at the element substrate 10 side (the rear surface side). The backlight device 90 has a light source 91 formed of a plurality of LEDs (light-emitting elements) or the like, and a light guiding plate 92 made of a transparent resin. A light beam emitted from the light source 91 is made incident on a side end surface of the light guiding plate 92, and is emitted from a light-emitting surface of the light guiding plate 92 toward the counter substrate 20. A ¼-wavelength plate 96 and a polarizing plate 97 are disposed between the light guiding plate 92 and the counter substrate 20. A ¼-wavelength plate 98 and a polarizing plate 99 are disposed at the counter substrate 20 side.

Pixel Structure

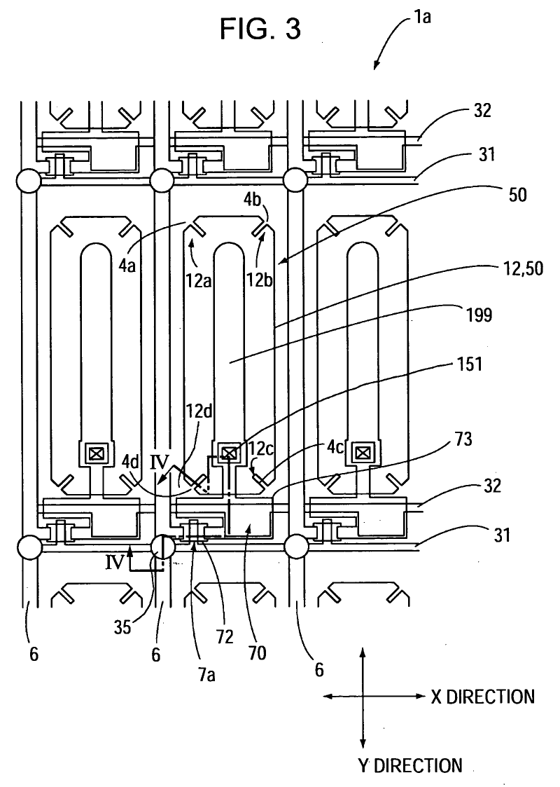

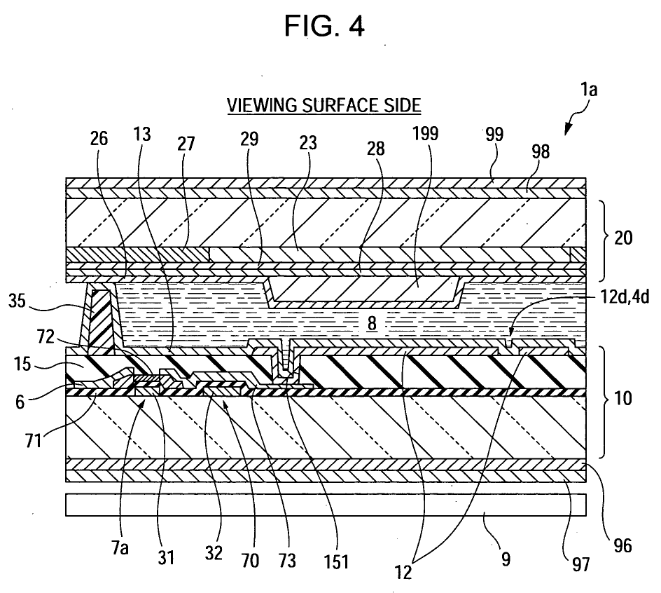

FIG. 3 is a plan view schematically illustrating a structure of a pixel corresponding to a single dot of the liquid crystal device according to the first embodiment of the invention. In FIG. 3, elements formed on the element substrate and elements formed on the counter substrate are shown to overlap each other without distinction. FIG. 4 is a cross-sectional view taken along the line IV-IV of FIG. 3, that is, an enlarged cross-sectional view of one of a plurality of pixels formed in the liquid crystal device according to the first embodiment of the invention.

As shown in FIGS. 3 and 4, on the inner surface of an element substrate 10 are formed a scanning line 31, a capacitor line 32, a gate insulating film 71, a semiconductor layer 72 made of a silicon film forming an active layer of a TFT 7a, a data line 6 (source electrode), a drain electrode 73, a transparent interlayer insulating film 15 made of a photosensitive resin, an inorganic oxide film or the like, a pixel electrode 12 made of ITO (Indium Tin Oxide) or the like, and an alignment film 13 (vertical alignment film) in this order. The pixel electrode 12 is electrically connected to the drain electrode 73 via a contact hole 151 of the interlayer insulating film 15, and the drain electrode 73 constitutes a storage capacitor 70 using the gate insulating film 71 as a dielectric between the capacitor line 32 and the drain electrode. In addition, on a counter substrate 20 are formed a color filter 23, a light shielding film 27, a planarizing film 29, a counter electrode 28 made of ITO or the like, and an alignment film 26 (vertical alignment film) in this order. As for the color filter 23, for each of the pixels 50, a predetermined color of color filter is formed. A pillar-shaped spacer 35 is formed on the element substrate 10 using a photosensitive resin. The pillar-shaped spacer 35 causes a predetermined gap to be formed between the element substrate 10 and the counter substrate 20, and the liquid crystal layer 8 is held in the gap.

In the liquid crystal device 1a constructed as described above, a liquid crystal material having negative dielectric anisotropy is used for the liquid crystal layer 8, and vertical alignment films are used for the alignment films 13 and 26. Therefore, the liquid crystal molecules in the liquid crystal layer 8 are vertically aligned to the substrate surface in a state in which a voltage is not applied. Furthermore, in the counter substrate 20, an alignment controlling protrusion 199 (alignment control unit) is formed at a location including the center of the pixel electrode 12 at the upper layer side of the counter electrode 28. For example, the alignment controlling protrusion 199 constitutes an inclined surface with the height of 1.2 μm having the pre-tilt at the interface of the alignment film 26. The alignment controlling protrusion 199 can be formed by developing a novolak positive type photoresist and post baking it. In the present embodiment, the contact hole 151 is formed at a location overlapping the alignment controlling protrusion 199.

In the present embodiment, as shown in FIG. 3, the planar shape of the pixel electrode 12 is an approximately rectangular shape, and wedge-like slits 4a, 4b, 4c, and 4d extending from the outer peripheries toward the center of the pixel electrode 12 are formed only at corner portions 12a, 12b, 12c, and 12d of the pixel electrode 12 and slits are not formed in the other portion of the pixel electrode 12. In the present embodiment, the width of each of the slits 4a, 4b, 4c, and 4d is set equal to or smaller than 8 μm at any place, and its length is within a range of 5 to 20 μm.

### Major Effect of the Present Embodiment

As described above, the liquid crystal device 1a according to the present embodiment performs light modulation by vertically aligning the liquid crystal molecules having negative dielectric anisotropy with respect to the substrate surface, and tilting the liquid crystal molecules by the voltage application. Also, in the liquid crystal device 1a according to the present embodiment, since the alignment controlling protrusion 199 that controls the alignment of the liquid crystal molecules is formed in an area including the center of the pixel electrode 12, the vertically aligned liquid crystal molecules at the center portion of the pixel electrode 12 can be tilted in all directions of 360 degrees. Accordingly, the liquid crystal device 1a according to the present embodiment has a wider visual angle.

Also, in the liquid crystal device 1a according to the present embodiment, since the alignment controlling protrusion 199 that controls the alignment of the liquid crystal molecules is formed in an area including the center of the pixel electrode 12, the vertically aligned liquid crystal molecules at the center portion of the pixel electrode 12 can be tilted in all directions of 360 degrees. Accordingly, disclination is fixed to the center portion of the pixel, thereby achieving a superior display quality.

Also, since the pixel electrode 12 has an approximately rectangular shape and the corner portions 12a, 12b, 12c, and 12d are spaced apart from the alignment controlling protrusion 199, the alignment could not be controlled by the alignment controlling protrusion 199. However, in the present embodiment, since the slits 4a, 4b, 4c, and 4d are formed at the corner portions 12a, 12b, 12c, and 12d, the alignment of the liquid crystal molecules can be controlled by the oblique electric field generated by the slits 4a, 4b, 4c, and 4d. Therefore, according to the present embodiment, since the slits 4a, 4b, 4c, and 4d are only formed in the areas that are most likely subject to alignment disorder, the alignment of the liquid crystal molecules can be controlled without forming a plurality of slits around the entire outer peripheries of the pixel electrode 12. Therefore, as compared with the case in which a plurality of slits are formed around the entire outer peripheries of the pixel electrode, brighter display with a higher pixel aspect ratio can be achieved.

Also, in the present embodiment, since the width of each of the slits 4a, 4b, 4c, and 4d is set equal to or smaller than 8 μm, there is no concern that the liquid crystal molecules of the entire pixel may be subject to alignment disorder because the effect of the oblique electric field generated by the slits 4a, 4b, 4c, and 4d are excessively large. Also, if the width of each of the slits 4a, 4b, 4c, and 4d is equal to or smaller than 8 μm, since the alignment of the liquid crystal molecules is controlled by the oblique electric field generated by the slits 4a, 4b, 4c, and 4d, portions corresponding to the silts 4a, 4b, 4c, and 4d can be light-modulated, thereby contributing to the display. Therefore, an amount of lost display light can be suppressed to a minimum, so that a bright image can be displayed.

It should be noted that although the present embodiment has exemplified a case in which the invention is applied to a transmissive liquid crystal device, the structure of the present embodiment can also be adopted to a reflective or transflective liquid crystal device.

### Second Embodiment

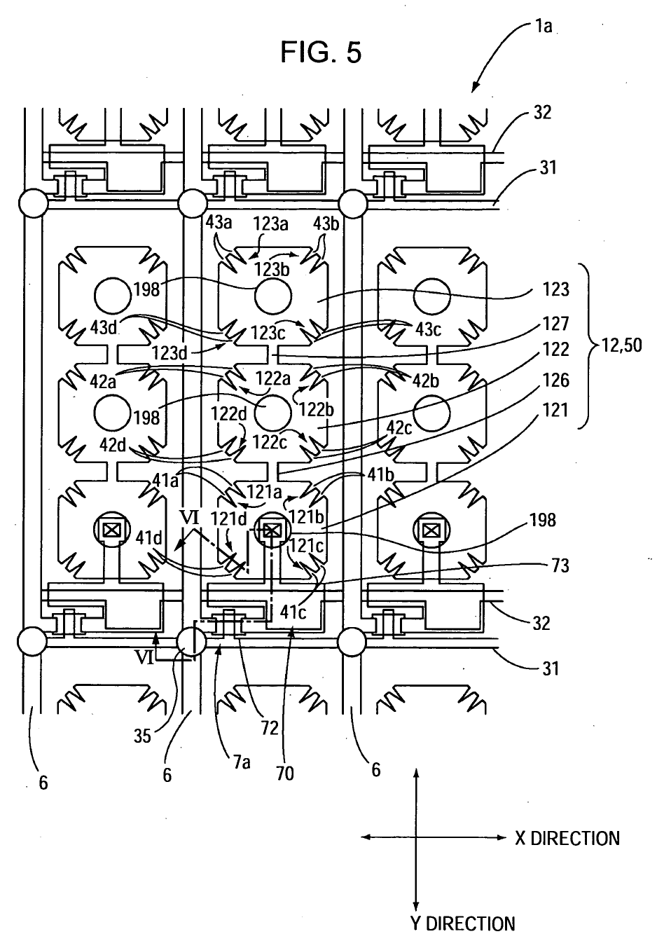

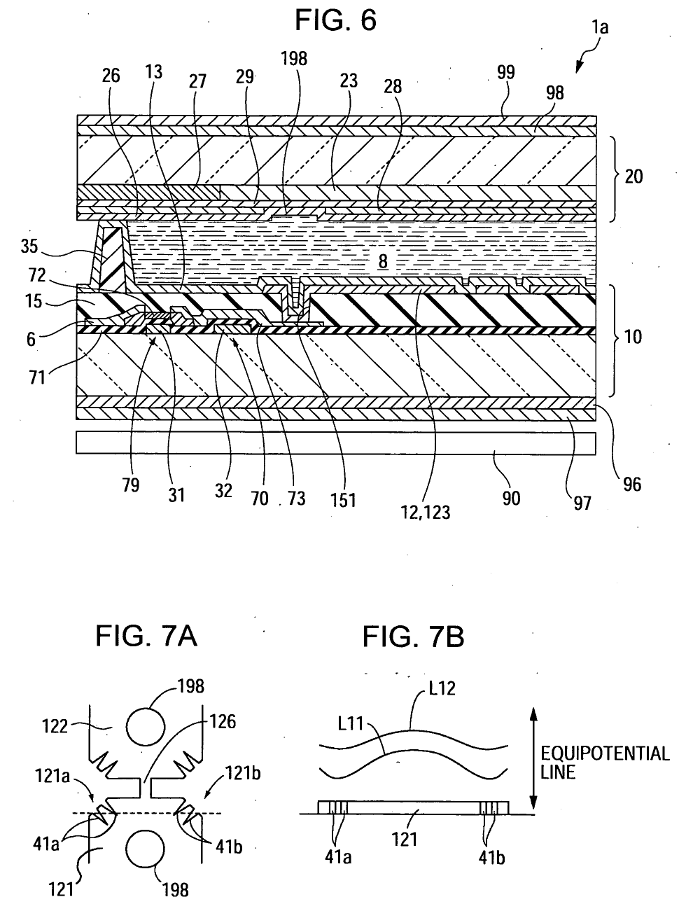

FIG. 5 is a plan view schematically illustrating a structure of a pixel corresponding to a single dot of a liquid crystal device according to a second embodiment of the invention. FIG. 6 is an enlarged cross-sectional view illustrating one of a plurality of pixels formed in the liquid crystal device according to the second embodiment of the invention, and corresponds to a cross-sectional view taken along the line VI-VI of FIG. 5. FIGS. 7A and 7B are diagrams illustrating equipotential lines when slits are formed in a sub-pixel electrode in the liquid crystal device according to the second embodiment of the invention. In addition, since a basic structure of the liquid crystal device according to the second embodiment is the same as that of the first embodiment, and the same constituent elements are denoted by the same reference numerals, and the description thereof will be omitted.

As in the first embodiment, the liquid crystal device 1a shown in FIGS. 5 and 6 is a transmissive active-matrix-type liquid crystal device using TFTs serving as the pixel switching elements. On the inner surface of an element substrate 10 are formed a scanning line 31, a capacitor line 32, a gate insulating film 71, a semiconductor layer 72 made of a silicon film forming an active layer of a TFT 7b, a data line 6, a drain electrode 73, a transparent interlayer insulating film 15 made of a photosensitive resin, an inorganic oxide film, or the like, a pixel electrode 12 made of ITO or the like, and an alignment film 13 (vertical alignment film) in this order. In addition, on the inner surface of a counter substrate 20 are formed a color filter 23, a light shielding film 27, a planarizing film 29, a counter electrode 28 made of ITO or the like, an alignment film 26 (vertical alignment film) in this order.

In the liquid crystal device 1a constructed as described above, a liquid crystal material having negative dielectric anisotropy is used for the liquid crystal layer 8, and vertical alignment films are used for the alignment films 13 and 26. Therefore, the liquid crystal molecules in the liquid crystal layer 8 are vertically aligned to the substrate surface in a state in which a voltage is not applied.

Furthermore, in the liquid crystal device 1a of the present embodiment, the pixel electrode 12 has CPA (Continuous Pinhole Alignment). In other words, the pixel electrode 12 is divided into three sub-pixel electrodes 121, 122, and 123 that are arranged along the direction where the data line 6 extends. Also, the sub-pixel electrode 121 and the sub-pixel electrode 122 are connected to each other by a connection portion 126 having a small width at the center therebetween in the width direction (X direction), and the sub-pixel electrode 122 and the sub-pixel electrode 123 are connected to each other by mean of a connection portion 127 having a small width at the center therebetween in the width direction (X direction). Here, each of the sub-pixel electrodes 121, 122, and 123 has an approximately rectangular planar shape.

Furthermore, in the counter substrate 20, an alignment controlling opening 198 (alignment control unit) is formed at each location including the center of each of the sub-pixel electrodes 121, 122, and 123 in the counter electrode 28. In the present embodiment, a contact hole 151 is formed at a location overlapping the alignment controlling opening 198 that is opposite to the center location of the sub-pixel electrode 121.

In the present embodiment, at the outer peripheries of the plurality of sub-pixel electrodes 121, 122, and 123, formed are wedge-like slits 41a, 41b, 42a, 42b, 42c, 42d, 43c, and 43d each extending in pairs at sides where the connection portions 126 and 127 are located, from both locations with the connection portions 126 and 127 therebetween toward the centers of the sub-pixel electrodes 121, 122, and 123. Specifically, since the sub-pixel electrodes 121, 122, and 123 have approximately rectangular shapes in the present embodiment, silts 41a, 41b, 42c, and 42d are formed in pairs at the four corner portions 121a, 121b, 122c, and 122d with the connection portion 126 therebetween at the sides where the connection portion 126 is located, and slits 42a, 42b, 43c, and 43d are formed in pairs at the four corner portions 122a, 122b, 123c, and 123d with the connection portion 127 therebetween at the sides where the connection portion 127 is located.

Furthermore, in the present embodiment, slits 41c, 41d, 43a, and 43b are formed in pairs extending toward the centers of the sub-pixel electrodes 121 and 123 at the other corner portions 121c, 121d, 123a, and 123b. It is noted that in the present embodiment, the width of each of the slits 41a, 41b, 41c, 41d, 42a, 42b, 42c, 42d, 43a, 43b, 43c, and 43d is equal to or smaller than 8 μm at any place, and each length of them is within a range of 5 to 20 μm.

As described above, the liquid crystal device 1a according to the present embodiment performs light modulation by vertically aligning the liquid crystal molecules having negative dielectric anisotropy with respect to the substrate surface, and tilting the liquid crystal molecules by the voltage application. Accordingly, the liquid crystal device 1a according to the present embodiment has a wider visual angle.

Also, in the liquid crystal device 1a of the present embodiment, since the pixel electrode 12 is divided into three sub-pixel electrodes 121, 122, and 123, the alignment of the liquid crystal molecules can be controlled by the oblique electric field generated at the outer peripheral portion of the pixel electrode 12. In this case, the sub-pixel electrodes 121, 122, and 123 are connected to one another via the connection portions 126 and 127, and the alignment of the liquid crystal molecules in the portions corresponding to the connection portions 126 and 127 cannot be controlled. In the present embodiment, however, since the slits 41a, 41b, 42a, 42b, 42c, 42d, 43c, and 43d formed at the outer peripheries of the sub-pixel electrodes 121, 122, and 123 extend in pairs toward the centers of the sub-pixel electrodes 121, 122, and 123 at both sides of the corner portions 121a, 121b, 122c, 122d and corner portions 122a, 122b, 123c, and 123d with the connection portions 126 and 127 interposed therebetween, the alignment of the liquid crystal molecules near the connection portions 126 and 127 can be controlled.

For example, an equipotential surface, when the sub-pixel electrode 121 where the slits 41a and 41b are formed is cut at the location shown in FIG. 7A, is shown by the solid line L11 in FIG. 7B, and an equipotential surface, when the sub-pixel electrode 121 where the slits. 41a and 41b are not formed is cut at the location shown in FIG. 7A, is shown by the solid line L12 in FIG. 7B. If the slits 41a and 41b are formed in the sub-pixel electrode 121, since the connection portion 126 is located between the slits 41a and 41b, the potential gradient of the potential gradient surface can be made larger. Therefore, it is possible to prevent disclination of the liquid crystal molecules generated on the connection portion 126 from migrating, thereby achieving a stable image display.

Furthermore, in the liquid crystal device 1a of the present embodiment, the alignment controlling opening 198 that controls the alignment of the liquid crystal molecules is formed in each of the areas including the centers of the sub-pixel electrodes 121, 122, and 123. Therefore, the vertically aligned liquid crystal molecules at the center portion of the pixel electrode 12 can be tilted in all directions of 360 degrees, and thus disclination does not occur. In this case, since the sub-pixel electrodes 121, 122, and 123 have approximately rectangular shapes, and the corner portions 121a, 121b, 121c, 121d, 122a, 122b, 122c, and 122d are spaced apart from the alignment controlling opening 198, the alignment cannot be controlled by the alignment controlling opening 198. In the present embodiment, however, since the slits 41a, 41b, 41c, 41d, 42a, 42b, 42c, 42d, 43a, 43b, 43c, and 43d are formed at any corner portion, the alignment of the liquid crystal molecules can be controlled by the oblique electric field generated by the slits.

Therefore, according to the present embodiment, since the slits 41a, 41b, 41c, 41d, 42a, 42b, 42c, 42d, 43a, 43b, 43c, and 43d are only formed in the areas that are most likely subject to alignment disorder, the alignment of the liquid crystal molecules can be controlled without forming a plurality of slits around the entire outer peripheries of the pixel electrode 12. Therefore, as compared with the case in which a plurality of slits are formed around the entire outer peripheries of the pixel electrode, brighter display with a higher pixel aspect ratio can be achieved.

Also, in the present embodiment, since the width of each of the slits 41a, 41b, . . . is set equal to or smaller than 8 μm, there is no concern that the liquid crystal molecules of the entire pixel may be subject to alignment disorder because the effect of the oblique electric field generated by the slits 41a, 41b, . . . is excessively large. Also, if the width of each of the slits 41a, 41b, . . . is equal to or smaller than 8 μm, since the alignment of the liquid crystal molecules can be controlled by the oblique electric field generated by the slits 41a, 41b, . . . , portions corresponding to the silts 41a, 41b, . . . can be light-modulated, thereby contributing to the display. Therefore, an amount of lost display light can be suppressed to a minimum, and a bright image can be displayed.

It should be noted that although the present embodiment has exemplified a case in which the invention is applied to a transmissive liquid crystal device, the structure of the present embodiment can also be adopted to a reflective or transflective liquid crystal device. Also, the present embodiment can be applied to a case in which the sub-pixel electrode has a circular or polygonal shape other than a rectangular shape.

### Third Embodiment

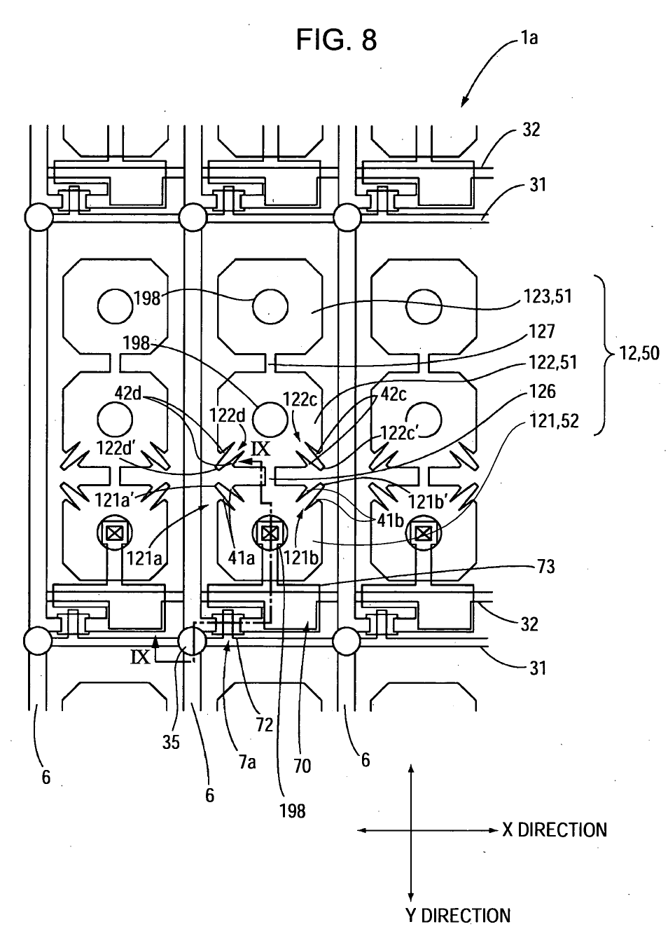

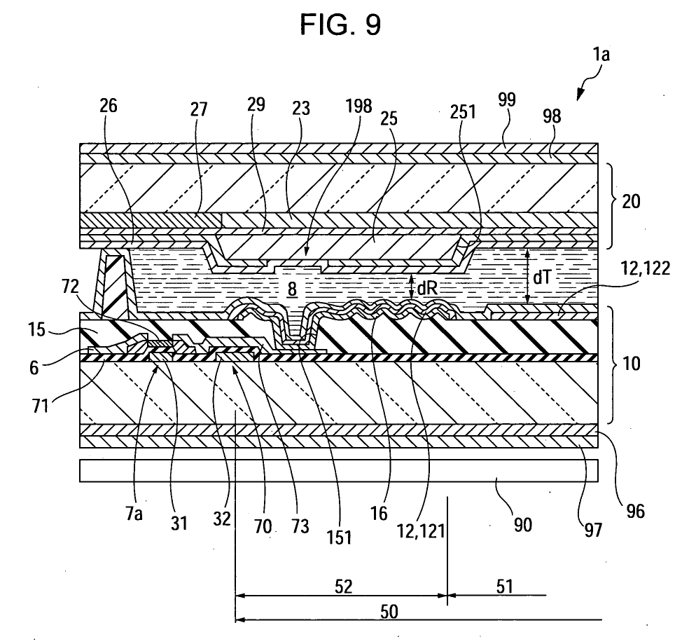

FIG. 8 is a plan view schematically illustrating a structure of a pixel corresponding to a single dot of a liquid crystal device according to a third embodiment of the invention. FIG. 9 is an enlarged cross-sectional view illustrating one of a plurality of pixels formed in the liquid crystal device according to the third embodiment of the invention, and corresponds to a cross-sectional view taken along the line IX-IX of FIG. 8. Since a basic structure of the liquid crystal device according to the present embodiment is the same as that of the first embodiment, the same constituent elements are denoted by the same reference numerals, and the description thereof will be omitted.

Differently from the first embodiment, the liquid crystal device 1a shown in FIGS. 8 and 9 is a transflective active-matrix-type liquid crystal device. A reflective layer 16 made of aluminum alloy, silver alloy, or the like is formed on the inner surface of the element substrate 10 in a region, which will be described in detail below, between an interlayer insulating film 15 and a pixel electrode 12. Also, the interlayer insulating film 15 is formed of a photosensitive resin as an unevenness forming layer having unevenness on its surface, and the unevenness is reflected as unevenness for light scattering on the surface of the reflective layer 16. In addition, the pixel electrode 12 is electrically connected to a drain electrode 73 via a contact hole 151 in the interlayer insulating film 15.

In addition, on a counter substrate 20, a color filter 23, a light shielding film 27, a planarizing film 29, a counter electrode 28 made of ITO or the like, an alignment film 26 (vertical alignment film) or the like are laminated in this order. A liquid-crystal-layer thickness adjusting layer 25 is formed on a region which is opposite to the reflective layer 16, which will be described in detail below.

In the liquid crystal device 1a constructed as described above, a liquid crystal material having negative dielectric anisotropy is used for the liquid crystal layer 8, and vertical alignment films are used for the alignment films 13 and 26. Therefore, the liquid crystal molecules in the liquid crystal layer 8 are vertically aligned to the substrate surface in a state in which a voltage is not applied.

Furthermore, in the liquid crystal device 1a according to the present embodiment, the pixel electrode 12 is divided into three sub-pixel electrodes 121, 122, and 123 arranged along the direction where the data line 6 extends, and the sub-pixel electrode 121 and the sub-pixel electrode 122 are connected to each other by a connection portion 126 having a small width. In addition, the sub-pixel electrode 122 and the sub-pixel electrode 123 are connected to each other by a connection portion 127 having a small width. In this case, each of the sub-pixel electrodes 121, 122, and 123 has an approximately rectangular planar shape.

Furthermore, in the counter substrate 20, an alignment controlling opening 198 (alignment control unit) is formed at each location including the center of each of the sub-pixel electrodes 121, 122, and 123 in the counter electrode 28. In the present embodiment, a contact hole 151 is formed at a location overlapping the alignment controlling opening 198 that is opposite to the center location of the sub-pixel electrode 121.

Furthermore, in the present embodiment, the reflective layer 16 is only formed in an area overlapping the sub-pixel electrode 123 in the plan view among the three sub-pixel electrodes 121, 122, and 123. Therefore, the area where the sub-pixel electrode 123 and the reflective layer 16 are formed functions as a reflective display region 52, and the area where the sub-pixel electrodes 121 and 122 are formed functions as a transmissive display region 51. That is, the transmissive display region 51 performs color display in a transmissive mode by emitting the light (light emitted from a backlight device 90) incident from the side opposite to the viewing surface side toward the viewing surface side, and the reflective display region 52 performs color display in a reflective mode by reflecting the external light incident from the viewing surface side toward the viewing surface side.

Furthermore, the liquid-crystal-layer thickness adjusting layer 25 is only formed on the reflective display region 52, and makes the thickness dR of the liquid crystal layer 8 in the reflective display region 52 smaller than the thickness dT of the liquid crystal layer 8 in the transmissive display region 51. For example, the liquid-crystal-layer thickness adjusting layer 25 makes the thickness dR of the liquid crystal layer 8 in the reflective display region 52 approximately the half of the thickness dT of the liquid crystal layer 8 in the transmissive display region 51.

In the liquid crystal device 1a constructed as described above, an end of the liquid-crystal-layer thickness adjusting layer 25 constitutes a step portion 251 having an oblique upward taper in the interface area between the reflective display region 52 and the transmissive display region 51. At the step portion 251, the liquid crystal molecules have a pre-tilt with respect to the surface of the substrate, and thus may be subject to alignment disorder. As a result, disclination can be easily migrated in the connection portion 126, thereby deteriorating the symmetry.

In the present embodiment, at the outer peripheries of the plurality of sub-pixel electrodes 121 and 122, wedge-like slits 41a, 41b, 42c, and 42d are formed in pairs that extend obliquely from both side portions located in the interface area between the reflective display region 52 and the transmissive display region 51 toward the centers of the sub-pixel electrodes 121, 122 and 123. That is, since the sub-pixel electrodes 121, 122, and 123 have approximately rectangular shapes in the present embodiment, silts 41a, 41b, 42c, and 42d are formed in pairs at the four corner portions 121a, 121b, 122c, and 122d that are located in the interface area between the reflective display region 52 and the transmissive display region 51.

In this case, the width of each of the slits 41a, 41b, 41c, and 41d is set equal to or smaller than 8 μm at any place, and each length of them is within a range of 5 to 20 μm. Furthermore, in the sub-pixel electrodes 121 and 122, a portion 121a′ sandwiched between the two slits 41a, a portion 121b′ sandwiched between the two slits 41b, a portion 122c′ sandwiched between the two slits 42c, and a portion 122d′ sandwiched between the two slits 42d protrude toward the outer peripheral sides when viewed from the contour (neighborhood) of the sub-pixel electrodes 121 and 122.

As described above, the liquid crystal device 1a according to the present embodiment performs light modulation by vertically aligning the liquid crystal molecules having negative dielectric anisotropy with respect to the substrate surface, and tilting the liquid crystal molecules by the voltage application. Also, since the alignment controlling opening 198 that controls the alignment of the liquid crystal molecules is formed in an area including each of the centers of the sub-pixel electrodes 121, 122, and 123, the vertically aligned liquid crystal molecules at the center portions of the sub-pixel electrodes 121, 122, and 123 can be tilted in all directions of 360 degrees. Accordingly, the liquid crystal device 1a according to the present embodiment has a wider visual angle.

Also, in the liquid crystal device 1a of the present embodiment, since the pixel electrode 12 is divided into three sub-pixel electrodes 121, 122, and 123, the alignment of the liquid crystal molecules can be controlled by the oblique electric field generated at the outer peripheral portion of the pixel electrode 12.

Furthermore, the liquid-crystal-layer thickness adjusting layer 25 is formed on the reflective display region 52, and makes the thickness dR of the liquid crystal layer 8 in the reflective display region 52 smaller than the thickness dT of the liquid crystal layer 8 in the transmissive display region 51. Accordingly, while the light emitted from the reflective display region 52 toward the viewing surface side passes through the liquid crystal layer 8 twice, the light emitted from the transmissive display region 51 toward the viewing surface side passes through the liquid crystal layer 8 only once. However, the difference in retardation (Δn·d) between the transmissive display light and the reflective display light can be eliminated. Therefore, since both the transmissive display light and the reflective display light are preferably light-modulated by the liquid crystal layer 8, both in the transmissive mode and the reflective mode, images of a high quality in terms of contrasts and the like can be displayed.

In this case, an end of the liquid-crystal-layer thickness adjusting layer 25 constitutes a step portion 251 having an oblique upward taper in the interface area between the reflective display region 52 and the transmissive display region 51. However, since the silts 41a, 41b, 42c, and 42d are formed in pairs at the four corner portions 121a, 121b, 122c, and 122d that are located in the interface area between the reflective display region 52 and the transmissive display region 51 in the sub-pixel electrodes 121 and 122, the alignment of the liquid crystal molecules near the interface area between the reflective display region 52 and the transmissive display region 51 can be controlled.

Therefore, according to the present embodiment, since the slits 41a, 41b, 42c, and 42d are only formed in the areas that are most likely subject to alignment disorder, the alignment of the liquid crystal molecules can be controlled without forming a plurality of slits around the entire outer peripheries of the pixel electrode 12. Therefore, as compared with the case in which a plurality of slits are formed around the entire outer peripheries of the pixel electrode, brighter display with a higher pixel aspect ratio can be achieved.

Further, in the present embodiment, since the width of each of the slits 41a, 41b, 42c, and 42d is set equal to or smaller than 8 μm, there is no concern that the liquid crystal molecules of the entire pixel may be subject to alignment disorder because the effect of the oblique electric field generated by the slits 41a, 41b, 42c, and 42d is excessively large. Furthermore, if the width of each of the slits 41a, 41b, 42c, and 42d is equal to or smaller than 8 μm, since the alignment of the liquid crystal molecules is controlled by the oblique electric field generated by the slits 41a, 41b, 42c, and 42d, portions corresponding to the silts 41a, 41b, 42c, and 42d can be light-modulated, thereby contributing to the display. Therefore, an amount of lost display light can be suppressed to a minimum, and a bright image can be displayed.

It is noted that the present embodiment can be applied to a case in which the sub-pixel electrode has a circular or polygonal shape other than a rectangular shape.

### Fourth Embodiment

The above-described first to third embodiments were examples in which the invention is applied to the active-matrix-type liquid crystal devices using TFTs serving as pixel switching elements. As described below, however, the invention is also applicable to an active-matrix-type liquid crystal device using TFDs (Thin Film Diodes) serving as pixel switching elements. Hereinafter, an example will be described where a structure according to the third embodiment of the invention is applied to an active-matrix-type liquid crystal device using TFDs serving as pixel switching elements. In addition, since a basic structure of the liquid crystal device according to the present embodiment is the same as that of the first embodiment, the same constituent elements are denoted by the same reference numerals.

Overall Structure

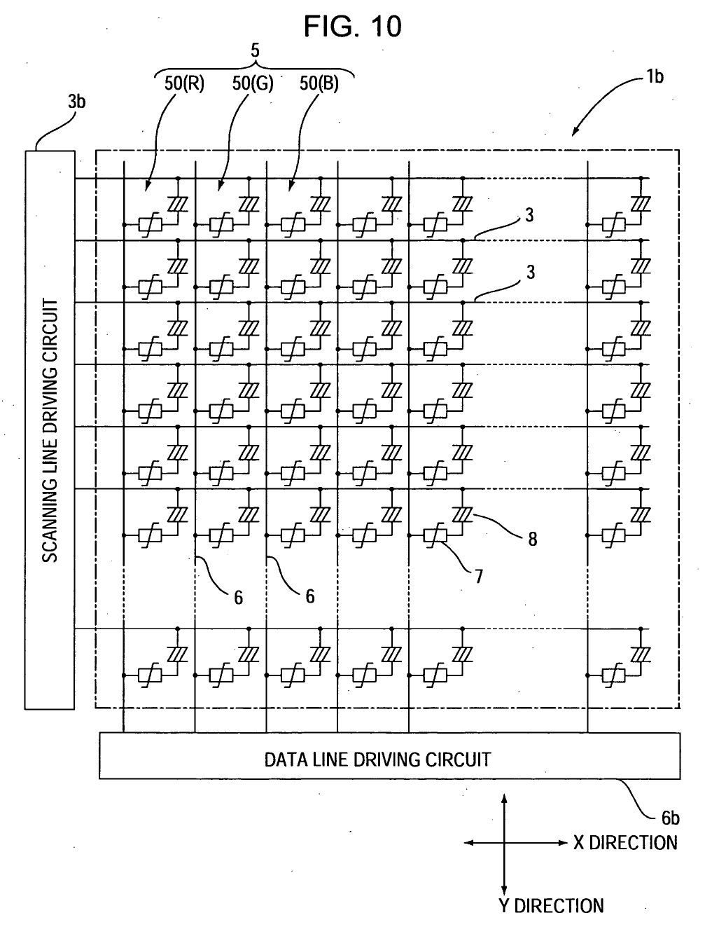

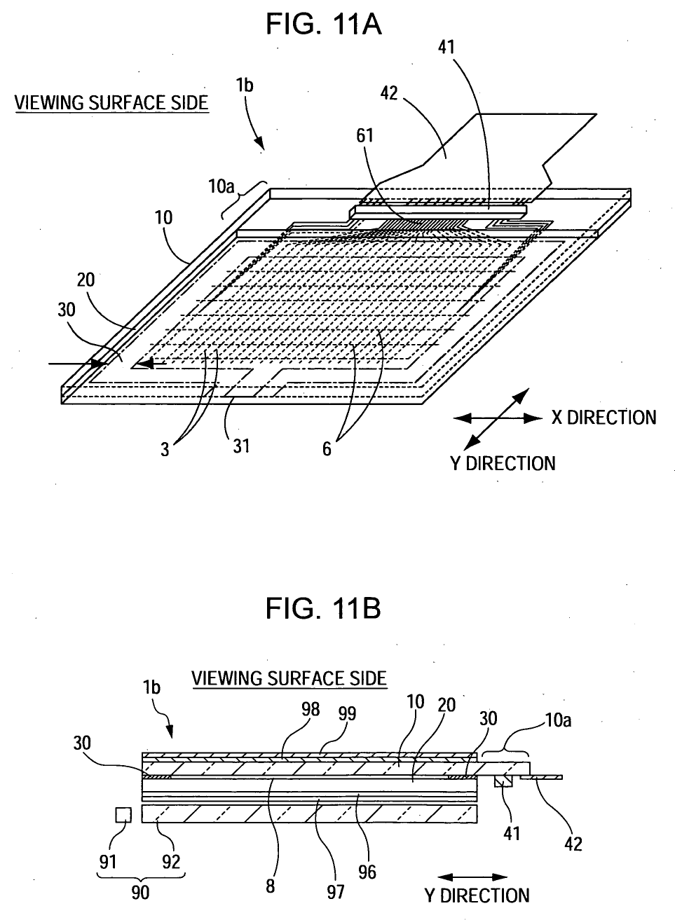

FIG. 10 is a block diagram illustrating an electrical structure of a liquid crystal device according to a fourth embodiment of the invention. FIG. 11A is a schematic perspective view of the liquid crystal device according to the fourth embodiment of the invention viewed from an oblique downside (counter substrate). FIG. 11B is a diagram schematically illustrating a cross section of the liquid crystal device when the liquid crystal device according to the fourth embodiment of the invention is cut in a Y direction.

The liquid crystal device 1b shown in FIG. 10 is a transflective active-matrix-type liquid crystal device using TFDs (Thin Film Diodes) serving as pixel switching elements. When two directions intersecting each other are denoted as an X direction and a Y direction, a plurality of data lines 6 extends in the Y direction (column direction), and a plurality of scanning lines 3 extends in the X direction (row direction). A pixel 50 (50(R), 50(G), 50(B)) is formed at a location corresponding to each of the intersections of the scanning lines 3 and the data lines 6, respectively, and a liquid crystal layer 8 and a pixel switching TFD 7b is connected in series to each other in each pixel 50. Each of the scanning lines 3 is driven by a scanning line driving circuit 3b, and each of the data lines 6 is driven by a data line driving circuit 6b.

Each of the plurality of pixels 50 corresponds to each of the red (R), green (G), and blue (B) according to the color of a color filter, which will be described in detail below. Each of the pixels 50(R), 50(G), and 50(B) corresponding to the three colors functions as a sub-dot, respectively, and the three pixels 50(R), 50(G), and 50(B) constitute a single dot 5. Accordingly, in the present embodiment, a plurality of dots 5 each of which has the three pixels 50(R), 50(G), and 50(B) are arranged in a matrix.

As shown in FIGS. 11A and 11B, in constituting the liquid crystal device 1b in the present embodiment, a liquid crystal layer 8 is formed by bonding an element substrate 10 (first substrate) disposed at the viewing surface side to a counter substrate 20 (second substrate) disposed at the side opposite to the viewing surface side via a sealant 30, and sealing a liquid crystal material serving as an electro-optical material in the region surrounded by both substrates and the sealant 30. The element substrate 10 and the counter substrate 20 are planar members having a light transmitting property, such as glass, quartz, or the like. The sealant 30 is formed along the outer periphery of the counter substrate 20 in an approximately rectangular frame shape, and a portion thereof is opened in order to insert the liquid crystal. Therefore, after the liquid crystal is inserted, the opening is sealed by a sealing material 33.

The element substrate 10 has an extending region 10a extending from one end of the counter substrate 20 to one side in a state in which it is bonded to the counter substrate 20 through the sealant 30, and a wiring pattern connected to the scanning lines 3 and the data lines 6 extends to the extending region 10a. A plurality of conductive particles are dispersed in the sealant 30. The conductive particles are plastic particles that are subjected to metal plating, resin particles having conductivity, or the like. The conductive particles have the function of electrically connecting the predetermined wiring patterns formed on the element substrate 10 and the counter substrate 20 to each other between the substrates. Therefore, in the present embodiment, an IC 41 for outputting signals to the scanning lines 3 and the data lines 6 is COG-mounted on the extending region 10a of the element substrate 10, and an end of the extending region 10a of the element substrate 10 is connected to a flexible substrate 42.

As shown in FIG. 11B, in the liquid crystal device 1b according to the present embodiment, a backlight device 90 is disposed at the counter substrate 20 side (the rear surface side). The backlight device 90 has a light source 91 formed of a plurality of LEDs (light-emitting elements) or the like, and a light guiding plate 92 made of a transparent resin. A light beam emitted from the light source 91 is incident on the side end surface of the light guiding plate 92, and is emitted from the light emitting surface of the light guiding plate 92 toward the counter substrate 20. A ¼-wavelength plate 96 and a polarizing plate 97 are disposed between the light guiding plate 92 and the counter substrate 20. A ¼-wavelength plate 98 and a polarizing plate 99 are disposed at the element substrate 10 side.

Pixel Structure

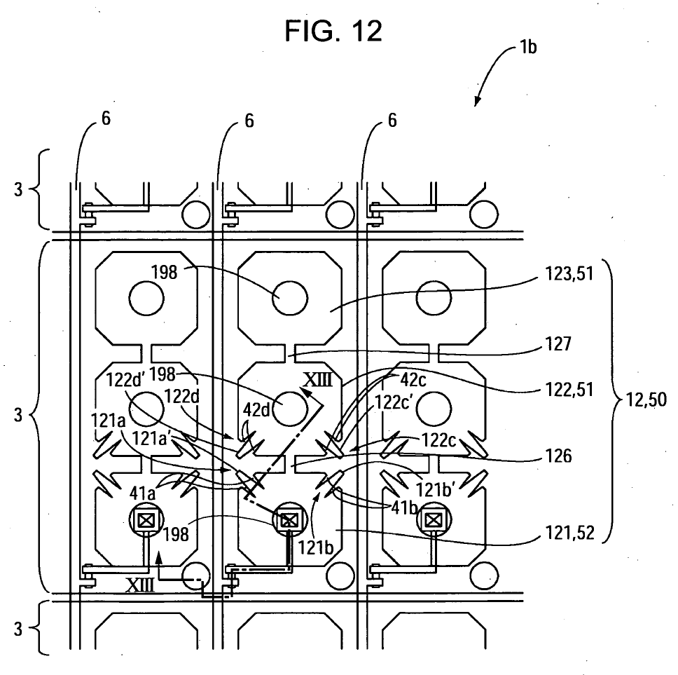

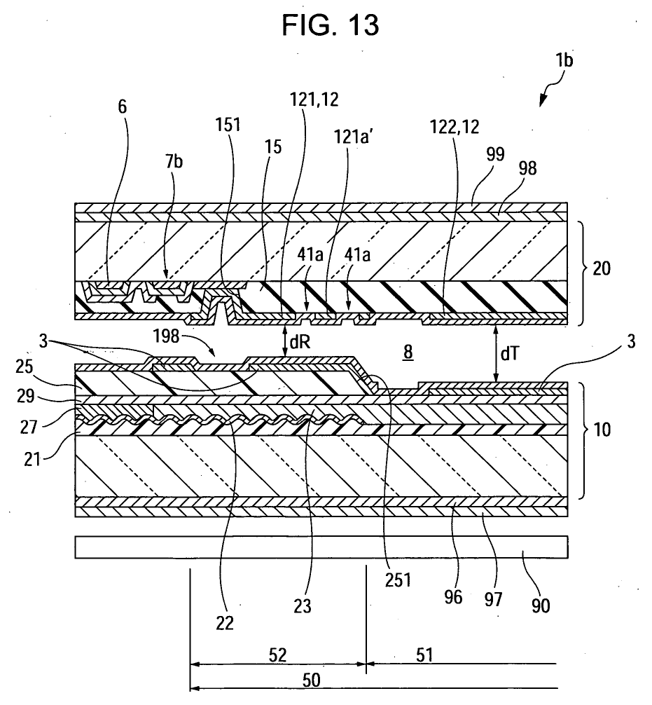

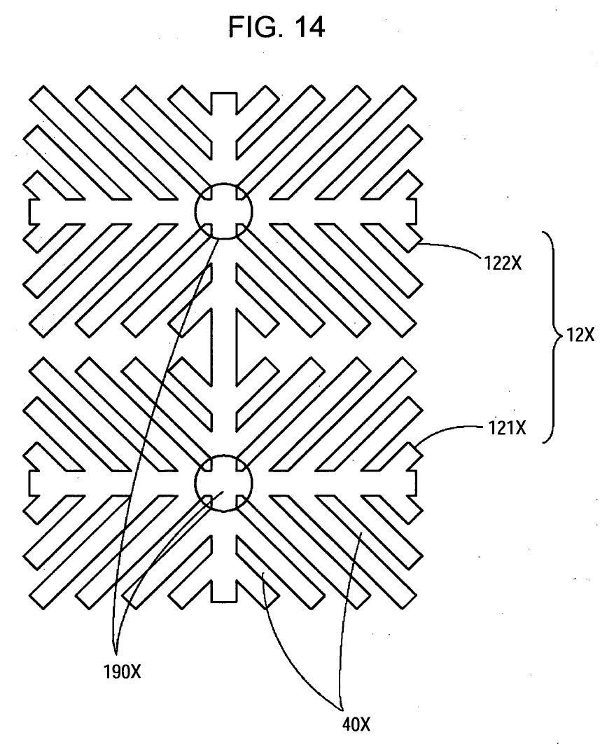

FIG. 12 is a plan view schematically illustrating a structure of a pixel corresponding to a single dot of the liquid crystal according to the fourth embodiment of the invention. FIG. 13 is an enlarged cross-sectional view of one of a plurality of pixels formed in the liquid crystal device according to the fourth embodiment of the invention, and corresponds a cross-sectional view taken along the line XIII-XIII of FIG. 12. In FIG. 12, elements formed on the element substrate and elements formed on the counter substrate 20 are shown so as to overlap each other without distinction.

As shown in FIGS. 12 and 13, a transparent base film (not shown), a plurality of data lines 6, TFDs 7b electrically connected to the data lines 6, a transparent interlayer insulating film 15 made of a silicon oxide film or the like, a transparent pixel electrode 12 made of ITO (Indium Tin Oxide), or the like, that is electrically connected to the TFD 7b via a contact hole 151 formed in the interlayer insulating film 15, and an alignment film 13 (vertical alignment film) are formed at the inner surface side (liquid crystal layer 8 side) of the element substrate 10. The pixel electrode 12 is electrically connected to the data line 6 via the TFD 7b. The TFD 7b is composed of two TFDs, and is formed in the order of the first metal film/oxide film/second metal film either viewed from the side of the data lines 6 or from the opposite thereof. Therefore, as compared with the case of using a single diode, the non-linear characteristic of the current-voltage relationship becomes symmetrical over both the positive and negative directions.

In addition, an unevenness forming layer 21 made of a transparent photosensitive resin, a reflective layer 22 made of aluminum alloy, silver alloy or the like, a color filter 23 and a light shielding film 27, a planarizing film 29, a liquid-crystal-layer thickness adjusting layer 25 made of a transparent photosensitive resin, a counter electrode (scanning electrode) having a stripe shape as a scanning line 3, and an alignment film 26 are laminated at the inner surface side of the counter substrate 20 (liquid crystal layer 8 side) in this order. The scanning line 3 is made of ITO or the like. In this case, the unevenness forming layer 21 has an unevenness formed on its surface, and the unevenness is reflected as unevenness for light scattering on the surface of the reflective layer 22.

In the liquid crystal device 1b constructed as described above, a liquid crystal material having negative dielectric anisotropy is used for the liquid crystal layer 8, and vertical alignment films are used for the alignment films 13 and 26. Therefore, the liquid crystal molecules in the liquid crystal layer 8 are vertically aligned to the substrate surface in a state in which a voltage is not applied.

Further, in the liquid crystal device 1b of the present embodiment, as in the third embodiment, the pixel electrode 12 is divided into three sub-pixel electrodes 121, 122, and 123 that are arranged along the direction where the data line 6 extends. The sub-pixel electrode 121 and the sub-pixel electrode 122 are connected to each other by a connection portion 126 having a small width. Furthermore, the sub-pixel electrode 122 and the sub-pixel electrode 123 are connected to each other by a connection portion 127 having a small width. In this case, each of the sub-pixel electrodes 121, 122, and 123 has an approximately rectangular planar shape.

In the counter substrate 20, an alignment controlling opening 198 (alignment control unit) is formed at each location including the center of each of the sub-pixel electrodes 121, 122, and 123 in the scanning line 3. In the present embodiment, the contact hole 151 is formed at a location overlapping the alignment controlling opening 198 that is opposite to the center location of the sub-pixel electrode 121.

Furthermore, in the present embodiment, the reflective layer 22 is only formed in an area overlapping the sub-pixel electrode 123 in the plan view among the three sub-pixel electrodes 121, 122, and 123. Therefore, the area where the sub-pixel electrode 123 and the reflective layer 22 are formed functions as a reflective display region 52, and the area where the sub-pixel electrodes 121 and 122 are formed functions as a transmissive display region 51.

Furthermore, the liquid-crystal-layer thickness adjusting layer 25 is only formed on the reflective display region 52, and makes the thickness dR of the liquid crystal layer 8 in the reflective display region 52 smaller than the thickness dT of the liquid crystal layer 8 in the transmissive display region 51. For example, the liquid-crystal-layer thickness adjusting layer 25 makes the thickness dR of the liquid crystal layer 8 in the reflective display region 52 approximately the half of the thickness dT of the liquid crystal layer 8 in the transmissive display region 51.

In the liquid crystal device 1b constructed as described above, an end of the liquid-crystal-layer thickness adjusting layer 25 constitutes a step portion 251 having an oblique upward taper in the interface area between the reflective display region 52 and the transmissive display region 51. At the step portion 251, the liquid crystal molecules have a pre-tilt with respect to the surface of the substrate, and thus may be subject to alignment disorder.

Accordingly, in the present embodiment, at the outer peripheries of the plurality of sub-pixel electrodes 121 and 122, wedge-like slits 41a, 41b, 42c, and 42d are formed in pairs that extend obliquely from both side portions located in the interface area between the reflective display region 52 and the transmissive display region 51 toward the centers of the sub-pixel electrodes 121 and 122. That is, since the sub-pixel electrodes 121, 122, and 123 have approximately rectangular shapes in the present embodiment, silts 41a, 41b, 42c, and 42d are formed in pairs at the four corner portions 121a, 121b, 122c, and 122d that are located in the interface area between the reflective display region 52 and the transmissive display region 51.

In this case, the width of each of the slits 41a, 41b, 41c, and 41d is set equal to or smaller than 8 μm at any place, and each length of them is within a range of 5 to 20 μm. Furthermore, in the sub-pixel electrodes 121 and 122, a portion 121a′ sandwiched between the two slits 41a, a portion 121b′ sandwiched between the two slits 41b, a portion 122c′ sandwiched between the two slits 42c, and a portion 122d′ sandwiched between the two slits 42d protrudes toward the outer peripheries when viewed from the contour of the sub-pixel electrodes 121 and 122.

### Major Effect of the Present Embodiment

As described above, the liquid crystal device 1b according to the present embodiment performs light modulation by vertically aligning the liquid crystal molecules having negative dielectric anisotropy with respect to the substrate surface, and tilting the liquid crystal molecules by the voltage application. Further, since the alignment controlling opening 198 that controls the alignment of the liquid crystal molecules is formed in an area including each of the centers of the sub-pixel electrodes 121, 122, and 123, the vertically aligned liquid crystal molecules at the center portions of the sub-pixel electrodes 121, 122, and 123 can be tilted in all directions of 360 degrees. Accordingly, the liquid crystal device 1b according to the present embodiment has a wider visual angle. Furthermore, since the pixel electrode 12 is divided into three sub-pixel electrodes 121, 122, and 123, the alignment of the liquid crystal molecules can be controlled by the oblique electric field generated at the outer peripheral portion of the pixel electrode 12. Furthermore, the liquid-crystal-layer thickness adjusting layer 25 makes the thickness dR of the liquid crystal layer 8 in the reflective display region 52 smaller than the thickness dT of the liquid crystal layer 8 in the transmissive display region 51. Accordingly, the difference in retardation (Δn·d) between the transmissive display light and the reflective display light can be eliminated. Therefore, both the transmissive display light and the reflective display light can be preferably light-modulated. In this case, an end of the liquid-crystal-layer thickness adjusting layer 25 constitutes a step portion 251 having an oblique upward taper in the interface area between the reflective display region 52 and the transmissive display region 51. However, since the silts 41a, 41b, 42c, and 42d are formed in pairs at the four corner portions 121a, 121b, 122c, and 122d that are located in the interface area between the reflective display region 52 and the transmissive display region 51 in the sub-pixel electrodes 121 and 122, the alignment of the liquid crystal molecules near the interface area between reflective display region 52 and the transmissive display region 51 can be controlled. Therefore, according to the present embodiment, since the alignment of the liquid crystal molecules can be controlled without forming a plurality of slits around the entire outer peripheries of the pixel electrode 12, as compared with the case in which a plurality of slits are formed around the entire outer peripheries of the pixel electrode, brighter display with a higher pixel aspect ratio can be achieved. That is, the present embodiment can achieve the same effect as the third embodiment.

Further, it should be noted that the present embodiment can be applied to a case in which the sub-pixel electrode has a circular or polygonal shape other than a rectangular shape.

### Other Embodiment

In the above-described embodiments, when the liquid crystal device is a transflective type, with respect to the color filter 23, a color filter for transmissive display may be formed in the transmissive display region 51, and a color filter for reflective display may be formed in the reflective display region 52. In such a case, the thickness and the type or composition percentage of the color material of the color filter for transmissive display are set to be the optimal condition for displaying color images in the transmissive mode, and the thickness and the type or composition percentage of the color material of the color filter for reflective display are set to the optimal condition for displaying color images in the reflective mode. Accordingly, while the light emitted from the reflective display region 52 toward the viewing surface side passes through the color filter for reflective display twice, the light emitted from the transmissive display region toward the viewing surface side passes through the color filter for transmissive display only once. However, both in the transmissive mode and in the reflective mode, excellent color reproducibility can be obtained, and brighter images can be displayed. In the above-mentioned embodiments, although pixels for color display corresponds to red (R), green (G), and blue (B), they can correspond to colors other than the red (R), green (G), and blue (B), for example, yellow, cyan, and magenta, etc.

Electronic Apparatus

The liquid crystal device according to the invention can be used as display units of electronic apparatuses, such as a cellular phone, a notebook computer, an liquid crystal television, a view-finder-type (or monitor-direct-view-type) video recorder, a digital camera, a car navigation device, a pager, an electronic notebook, an electronic calculator, a word processor, a workstation, a video telephone, or the like.

What is claimed is:

1. A liquid crystal device comprising:
a first substrate that has an inner surface on which a pixel electrode is formed;
a second substrate that has an inner surface on which a counter electrode constituting a pixel is formed opposite to the pixel electrode; and
a liquid crystal layer that is held between the first substrate and the second substrate and has negative dielectric anisotropy;
wherein an alignment control unit that controls alignment of liquid crystal molecules is formed in an area including a center of the pixel electrode on either the first substrate or the second substrate; and
the pixel electrode has an approximately polygonal shape, and slits extending from outer peripheries toward a center are formed at corner portions of the pixel electrode.

2. The liquid crystal device according to claim 1,
wherein the alignment control unit is formed of one of:
a protrusion formed in an area including the center of the pixel electrode in at least one of the inner surface of the first substrate and the inner surface of the second substrate; and
an opening formed in an area including the center of the pixel electrode in at least one of the pixel electrode and the counter electrode.

3. A liquid crystal device comprising:
a first substrate that has an inner surface on which a pixel electrode is formed;
a second substrate that has an inner surface on which a counter electrode constituting a pixel is formed opposite to the pixel electrode; and
a liquid crystal layer that is held between the first substrate and the second substrate and has negative dielectric anisotropy;
wherein the pixel electrode is divided into a plurality of sub-pixel electrodes connected via connection portions; and
slits are formed at outer peripheries of the plurality of sub-pixel electrodes, the slits extending from both sides of the corresponding pixel electrodes with the connection portions interposed therebetween at sides where the connection portions are located toward centers of the corresponding sub-pixel electrodes.

4. The liquid crystal device according to claim 3,
wherein each of the sub-pixel electrodes has an approximately polygonal shape; and
the slits extend from corner portions of both sides of outer peripheries of the plurality of sub-pixel electrodes with the connection portions interposed therebetween at sides where the connection portions are located toward centers of the corresponding sub-pixel electrodes.

5. A liquid crystal device comprising:
a first substrate that has an inner surface on which a pixel electrode is formed;
a second substrate that has an inner surface on which a counter electrode constituting a pixel is formed opposite to the pixel electrode; and
a liquid crystal layer that is held between the first substrate and the second substrate and has negative dielectric anisotropy;
wherein the pixel electrode is divided into a plurality of sub-pixel electrodes connected via connection portions,
each of the plurality of sub-pixel electrodes is disposed so as to correspond to a transmissive display region that emits light incident from either the first substrate or the second substrate toward the other substrate and a reflective display region that reflects light incident from either the first substrate or the second substrate;
the reflective display region has a liquid-crystal-layer thickness adjusting layer that makes a thickness of the liquid crystal layer in the corresponding reflective display region smaller than a thickness of the liquid crystal layer in the transmissive display region; and
slits are formed in each of the plurality of sub-pixel electrodes, the slits extending from both sides of the corresponding sub-pixel electrode located at an interface area side between the reflective display region and the transmissive display region toward a center of the corresponding sub-pixel electrode.

6. The liquid crystal device according to claim 5,
wherein each of the sub-pixel electrodes has an approximately polygonal shape; and
the slits extend from corner portions of outer peripheries of the plurality of sub-pixel electrodes which are located at interface areas toward centers of the corresponding sub-pixel electrodes.

7. The liquid crystal device according to claim 3,
wherein an alignment control unit that controls an alignment of liquid crystal molecules is formed in an area including the center of each of the sub-pixel electrodes on either the first substrate or the second substrate.

8. The liquid crystal device according to claim 7,
wherein the alignment control unit is formed of one of:
a protrusion formed in an area including the center of the sub-pixel electrode in at least one of the inner surface of the first substrate and the inner surface of the second substrate; and
an opening formed in an area including the center of the sub-pixel electrode in at least one of the pixel electrode and the counter electrode.

9. The liquid crystal device according to claim 1,
wherein a plurality of slits are formed parallel to each other at one place.

10. The liquid crystal device according to claim 9,
wherein a portion sandwiched by the slits protrudes more toward the outer peripheral side than a peripheral portion.

11. The liquid crystal device according to claim 1,
wherein a width of each of the slits is equal to or less than 8 μm.

12. An electronic apparatus comprising the liquid crystal device according to claim 1.
